(19) United States
(12) Patent Application Publication
(10) Pub. No.: US 2011/0295613 A1
(43) Pub. Date: Dec. 1, 2011

(54) Inpatient utilization management system and method

(76) Inventor: Martin Coyne, Santa Monica, CA (US)

(21) Appl. No.: 12/802,106

(22) Filed: May 28, 2010

(51) Int. Cl. G06Q 50/00; G06Q 10/00

(52) U.S. Cl. 705/2

(57) ABSTRACT

A method for admitting a patient includes creating an inpatient value set by collecting a respective value for each of a plurality of datapoints about the patient. The inpatient value set can then be compared with an historical dataset, the dataset representing a plurality of other patients each having a respective corresponding value set for the plurality of datapoints associated with a respective set of utilization management information. Based on the comparison, a particular set of utilization management information that is associated with a particular corresponding value set which is substantially the same as the inpatient value set is identified within the historical dataset. Ultimately, based on the particular set of utilization management information, a predicted length of stay for the patient is calculated.

### FIELD OF THE INVENTION

The present invention relates to utilization management techniques and, more particularly, to an inpatient utilization management system and method.

### BACKGROUND OF THE INVENTION

A modern healthcare team comprises physicians, ancillary providers, nurses, and hospital administrator, with input from patient and family members. In the current hospital environment, these participants often have competing goals. Improving efficient management is a low priority for physicians but not for the case managers and hospital administrators. Despite the fact that physicians have numerous competing interests, the physician staff typically remains the focus of any attempt to improve inpatient efficiencies. The reason for this is the so-called “power of the pen”, which alludes to the public's belief supported by the legal system that the physician should and does have full authority in regard to medical management.

Ancillary services are crucial to the smooth and efficient flow of the workup of the patient, but local department needs and concerns often deflect from the goal of efficiency. Staffing and scheduling issues within an ancillary department are some of the main obstacles. For example, the scheduling of endoscopy on a patient with GI hemorrhage is often determined more by staffing issues than the need for efficient workup and discharge.

Case managers and discharge planners are routinely assigned the responsibility of discharging patients. But they need the cooperation of the attending staff and the ancillary departments to adequately perform their duties. For the nursing staff of a hospital, lack of tools to communicate their goals of discharge to other team members is one factor that interferes with their job performance and job satisfaction.

Even in view of all these factors, the standard tools of case management are designed to be used exclusively by them and are not designed to include other team members. Compounding the isolation of the utilization management (UM) case manager is the fact that personal communication with the attending physician is often difficult because of differing rounding schedules and perceived physician prerogatives. The result is a personalized, anecdotal communication between UM nurse and physician that fosters an atmosphere of non-cooperation and team dysfunction. Similarly, communication with the patient's family can be logistically difficult, causing delays in discharge.

Thus, there remains an, as of yet, unmet need for a re-engineering of the UM workflow process that promotes integration and cooperation within the healthcare team.

### SUMMARY OF THE INVENTION

Embodiments of the present invention relate to utilization management techniques and, more particularly, to an inpatient utilization management system and method. In particular, a method for admitting a patient includes creating an inpatient value set by collecting a respective value for each of a plurality of datapoints about the patient. The inpatient value set can then be compared with an historical dataset, the dataset representing a plurality of other patients each having a respective corresponding value set for the plurality of datapoints associated with a respective set of utilization management information. Based on the comparison, a particular set of utilization management information that is associated with a particular corresponding value set which is substantially the same as the inpatient value set is identified within the historical dataset. Ultimately, based on the particular set of utilization management information, a predicted length of stay for the patient is calculated.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

FIG. 1 illustrates an exemplary environment of an inpatient utilization management system operating in accordance with the principles of the present invention.

FIG. 2 illustrates a flowchart of a method of generating utilization management information in accordance with the principles of the present invention.

FIGS. 3-25C are exemplary user interface screens illustrating features of an inpatient management system that can utilize UM information in accordance with the principles of the present invention.

### DETAILED DESCRIPTION OF THE PREFERRED EMBODIMENTS

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

Various aspects of the present invention may be embodied as systems, computer-implemented methods and computer program products. Also, various aspects of the present invention may take the form of an entirely hardware embodiment, an entirely software embodiment (including software, firmware, micro-code, etc.) or an embodiment combining software and hardware, wherein the embodiment or aspects thereof may be generally referred to as a “circuit,” “component” or “system.” Furthermore, the various aspects of the present invention may take the form of a computer program product on a computer-usable storage medium having computer-usable program code embodied in the medium or a computer program product accessible from a computer-usable or computer-readable medium providing program code for use by or in connection with a computer or any instruction execution system.

The software aspects of the present invention may be stored, implemented and/or distributed on any suitable computer usable or computer readable medium(s). For the purposes of this description, a computer-usable or computer readable medium can be any apparatus that can contain, store, communicate, propagate, or transport the program for use by or in connection with the instruction execution system, apparatus, or device. The computer program product aspects of the present invention may have computer usable or computer readable program code portions thereof, which are stored together or distributed, either spatially or temporally across one or more devices. A computer-usable or computer-readable medium may comprise, for example, an electronic, magnetic, optical, electromagnetic, infrared, or semiconductor system, apparatus, device, or propagation medium. As yet further examples, a computer usable or computer readable medium may comprise cache or other memory in a network processing device or group of networked processing devices such that one or more processing devices stores at least a portion of the computer program product. The computer-usable or computer-readable medium may also comprise a computer network itself as the computer program product moves from buffer to buffer propagating through the network. As such, any physical memory associated with part of a network or network component can constitute a computer readable medium.

More specific examples of the computer usable or computer readable medium comprise for example, a semiconductor or solid state memory, magnetic tape, an electrical connection having one or more wires, a swappable intermediate storage medium such as floppy drive or other removable computer diskette, tape drive, external hard drive, a portable computer diskette, a hard disk, a rigid magnetic disk, a random access memory (RAM), a read-only memory (ROM), an erasable programmable read-only memory (EPROM or Flash memory), a portable compact disc read-only memory (CD-ROM), a read/write (CD-R/W) or digital video disk (DVD), an optical fiber, disk or storage device, or a transmission media such as those supporting the Internet or an intranet. The computer-usable or computer-readable medium may also comprise paper or another suitable medium upon which the program is printed or otherwise encoded, as the program can be captured, for example, via optical scanning of the program on the paper or other medium, then compiled, interpreted, or otherwise processed in a suitable manner, if necessary, and then stored in a computer memory. The computer-usable medium may include a propagated data signal with the computer-usable program code embodied therewith, either in baseband or as part of a carrier wave or a carrier signal. The computer usable program code may also be transmitted using any appropriate medium, including but not limited to the Internet, wire line, wireless, optical fiber cable, RF, etc.

A data processing system suitable for storing and/or executing program code may include at least one processor coupled directly or indirectly to memory elements, e.g., through a system bus or other suitable connection. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in any suitable language, including for example, an object oriented programming language such as Java, Smalltalk, C++ or the like. The computer program code for carrying out operations of the present invention may also be written in conventional procedural programming languages, such as the “C” programming language, or in higher or lower level programming languages. The program code may execute entirely on a single processing device, partly on one or more different processing devices, as a stand-alone software package or as part of a larger system, partly on a local processing device and partly on a remote processing device or entirely on the remote processing device. In the latter scenario, the remote processing device may be connected to the local processing device through a network such as a local area network (LAN) or a wide area network (WAN), or the connection may be made to an external processing device, for example, through the Internet using an Internet Service Provider.

The processing devices may comprise for example, servers, personal computers, notebook computers, transactional systems, appliance or pervasive computing devices such as personal data assistants (PDA), palm computers, cellular access processing devices, special purpose computing devices and/or other devices capable of interacting with the system, and may thus be implemented in hardware, software, or a combination of hardware and software.

The various processing devices may be supported by networking components such as routers, hubs, firewalls, network interfaces, wired or wireless communications links and corresponding interconnections. Moreover, the network system may comprise one or more intranets, extranets, local area networks (LAN), wide area networks (WAN), wireless networks (WIFI), the Internet, including the World Wide Web, and/or other arrangements for enabling communication between the processing devices, either real time or otherwise, e.g., via time shifting, batch processing, etc.

Those of ordinary skill in the art will appreciate that the hardware may vary, depending on the implementation. For example, the above described components may be integrated or implemented as separate components. The depicted example is not meant to imply architectural limitations with respect to the present invention. Moreover, the above configuration is shown by way of illustration and not by way of limitation. As such, other processing system configurations may be implemented.

The present invention is described with reference to flowchart illustrations and/or block diagrams of methods, apparatus systems and computer program products according to embodiments of the invention. It will be understood that each block of the flowchart illustrations and/or block diagrams, and combinations of blocks in the flowchart illustrations and/or block diagrams may be implemented by system components or computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention may be practiced on any form of computer system, including a stand alone computer or one or more processors participating on a distributed network of computers. Thus, computer systems programmed with instructions embodying the methods and/or systems disclosed herein, or computer systems programmed to perform various aspects of the present invention and storage or storing media that store computer readable instructions for converting a general purpose computer into a system based upon the various aspects of the present invention disclosed herein, are also considered to be within the scope of the present invention. Once a computer is programmed to implement the various aspects of the present invention, including the methods of use as set out herein, such computer in effect, becomes a special purpose computer particular to the methods and program structures of this invention. The techniques necessary for this are well known to those skilled in the art of computer systems.

Any flowcharts and block diagrams in the figures illustrate the architecture, functionality, and operation of possible implementations of systems, methods and computer program products according to various embodiments of the present invention. In this regard, one or more blocks in the flowchart or block diagrams may represent a component, segment, or portion of code, which comprises one or more executable instructions for implementing the specified logical function(s). In some alternative implementations, the functions noted in the blocks may occur out of the order noted in the figures. For example, two blocks shown in succession may, in fact, be executed substantially concurrently or in the reverse order.

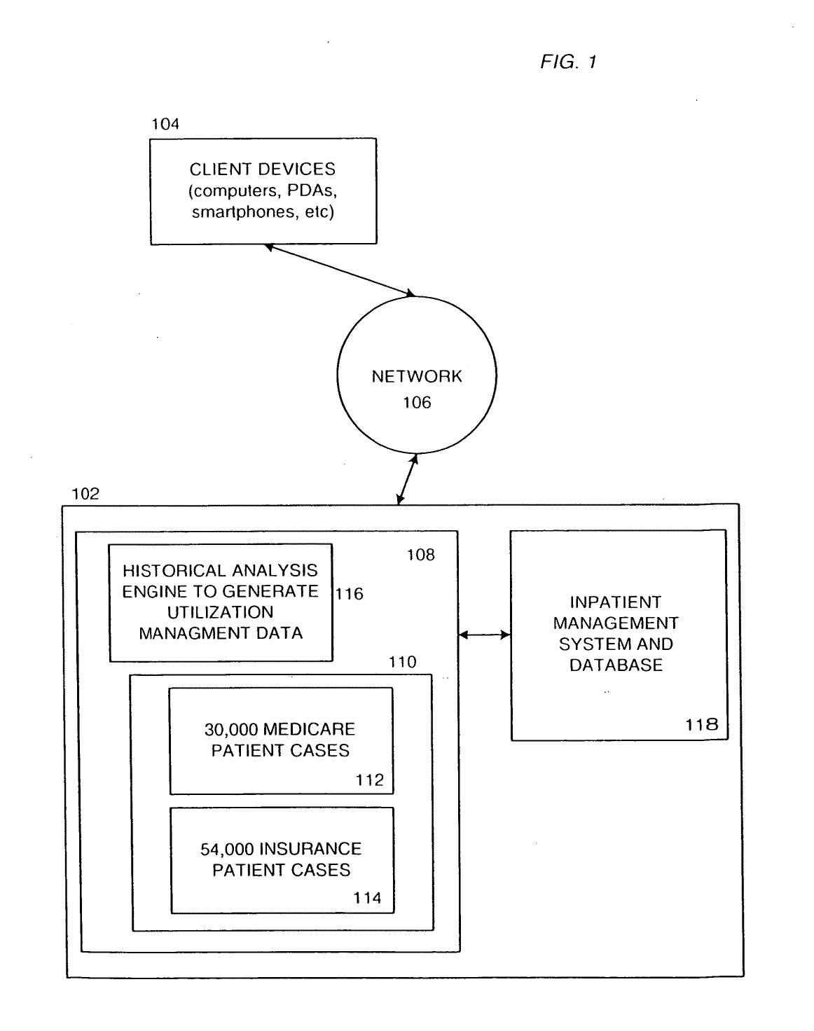

FIG. 1 illustrates an exemplary automated environment of an inpatient utilization management system operating in accordance with the principles of the present invention. The overall system 102 includes a number of component parts that perform together to provide an application as a web service to a plurality of client devices 104 over a network 106. Although FIG. 1 explicitly shows only one client device 104, it is understood that multiple client devices 104, at various geographical locations, can concurrently connect through the network 106 to the system 102.

In one contemplated embodiment, the system 102 implements a web service application and the client devices 104 can connect using a standard web browser. Alternatively, the system 102 can be implemented as a proprietary client-server application with a specialized client portion residing on the client devices 104. Additionally, for example with an iPhone or similar device, portions of the system 102 can be communicated with using a web browser while other portions can take advantage of a specialized iPhone app. The benefit from these types of environments is that a user with a client device 104 can access the system 102, and realize its benefits, without having to be physically local to the system 102.

The system 102 provides a number of functions but can be logically separated into two different core functionalities. One core function 108 relates to providing utilization management (UM) information to an inpatient management system and database 118. This UM information, as explained more fully below, is generated when admitting a patient into the inpatient management system and database 118.

The inpatient management system and database 118 includes an electronic records database for patient information, a report generating function for providing reporting capabilities for a variety of information about patients, and communication modules for facilitating written and electronic communication between different members of the healthcare team. The system and database 118 can provide other functions, as well, as more fully described below.

The generation of the UM information relies on an analysis engine 116 and a historical dataset 110. In one embodiment, the analysis engine 116 relies on a dataset 110 that includes a database 112 of about 30,000 patients that relied on Medicare to pay for a portion of their treatment and another database 114 of over 50,000 patients that relied on an insurance provider to pay for a portion of their treatment. Based on the patient information of a patient being admitted, the information within the historical dataset 110 can be utilized with the analysis engine 116 to provide a prediction of the UM information for that patient. Thus, a dataset 110 can be utilized that represents actual clinical experience by practicing physicians and nurses.

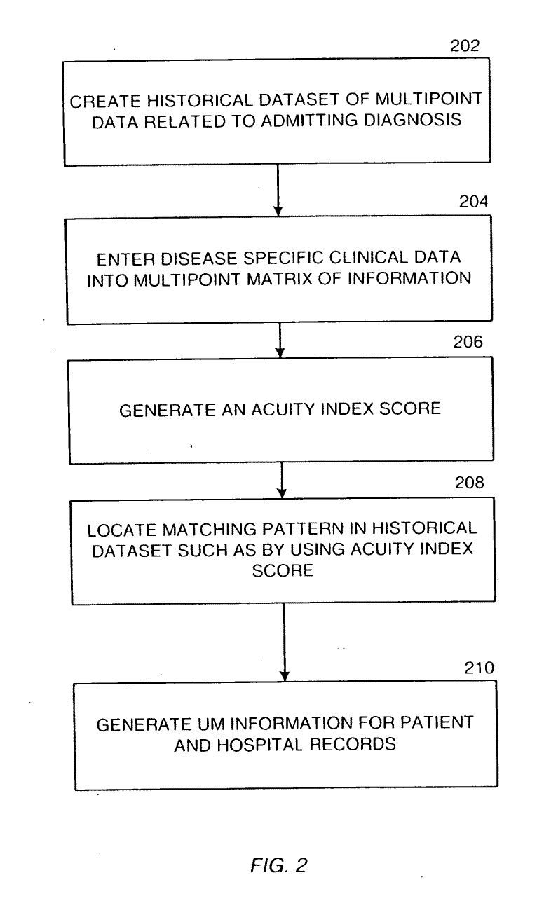

In general terms, the patient information from the dataset 110 is used to find a historical prediction about what type of care and treatment is likely to occur for a patient being newly admitted (or for an already-admitted patient's change of status). This historical prediction is then useful to an inpatient management system and database 118 that tracks UM information. FIG. 2 provides a flowchart of one exemplary method by which the analysis engine 116 can provide UM information in accordance with the principles of the present invention. As a preliminary step 202, the data within the dataset 110 can be organized into a summary-type table that condenses the information so that finding a matching pattern within the dataset is easier and more efficient. For example, if the dataset 110 has entries corresponding to 2500 patients whose admitting diagnosis was congestive heart failure, then the data from those database entries can be summarized so that locating and matching a multipoint pattern within the dataset 110 is easier. Thus, returning to FIG. 1, the dataset 110 does not necessarily include two actual databases 112 and 114 but, rather, the dataset 110 represents the information within the underlying data of the two databases 112 and 114 that allow prediction of UM information for a new patient.

In step 204, when a new patient is admitted or an already-admitted patient's condition or status changes, then data is collected that allows comparison with the information within the dataset 110. As one of ordinary skill will recognize, there is typically a variety of information that is available to be collected about a patient and most of this would be useful for predicting UM information for that patient. However, not all of the possible information is equally as helpful and too much information reduces efficiency and speed of automated processes. Accordingly, a set of exemplary data points is provided below that have proven effective at reliably forecasting UM information regarding a patient. One of ordinary skill will appreciate that other data points could be included or substituted, as some data points removed, without departing from the intended scope of the present invention.

One important data point includes the admitting diagnosis of the patient and then eight other exemplary data points that can be collected in step 204 include: 1) Vital Signs; 2) General Supportive Measures (e.g., IV fluids, medications, antibiotics, intubations, etc.); 3) Physical Findings relevant to the specific diagnosis; 4) Studies Pending (e.g., CT scan); 5) Study Findings; 6) Procedure(s) pending (e.g., cardiac catheterization); 7) Procedure findings; and 8) Expected Outcomes (e.g., sending patient home, to a nursing home, or to a health care facility. Another data point that may also be useful, if applicable, is whether or not the patient is being readmitted within one month with the same diagnosis.

Once the multipoint data is collected for the patient (typically during the admitting process), a matching pattern can be located within the dataset 110. The process of matching can be accomplished using a number of available statistical methods and techniques. However, the goal is to locate historical patient patterns that have the same admitting diagnosis and that most closely match with the 8 data points identified above. For that matching pattern or patterns, there is associated historical information regarding the hospital stay of the historical patients matching that pattern.

Steps 206 and 208 relate to one particular way to identify matching patterns in the dataset. For example in step 206, the 8 datapoints are used to generate or calculate an acuity index. This acuity index is also calculated for each patient record in the database. Based on the acuity index and the admitting diagnosis, the data within the dataset 110 associated with the matching cohort of patients can be located (in step 208). This associated clinical information is used to generate, in step 210, UM information for the new patient.

There are a variety of ways to calculate or generate the acuity index score. One exemplary method is to use a scale of 1 to 10. The different permutations of values for the 8 datapoints are then mapped to a number on the scale. This mapping can be accomplished using a subject-matter expert that has the knowledge and experience to map the information from the datapoints into an acuity score. A scale of 1 to 10 is exemplary and a finer granularity can be used, for example, if the datapoints were mapped to a scale of 1 to 25.

One of ordinary skill will appreciate that a variety of different information can be utilized to track and predict utilization management of patients and medical resources; however specific types of information are discussed below to provide concrete examples that help in explaining different aspect of the present invention.

Providing these examples is not intended to limit the scope of the present invention to only these values and data points. For example, the following types of UM information can be generated in step 208. Some of this information can be generated by the analysis engine 116 and other UM information can be calculated by the inpatient management system and database 118:

Predicted Length of stay (LOS): This is based on the information within the matching pattern(s) of the dataset 110. Thus, this value reflects real-life experience in managing that diagnosis in the local community. As such, it is designed to carry credibility with the practicing physician. Because of its clinical significance, it is a value that can be used in subsequent calculations and algorithms.

Estimated date of discharge: This is calculated from the date of admission using the predicted clinical length of stay.

Medicare observation vs. acute status: This is calculated by comparing the clinical profile for the patient to the matrix in the database. The value scanned is Medicare status. This algorithm may for example use a subset of the hospital database of Medicare patients hospitalized for a 12 month period. For example, within a DRG under Medicare a patient can be considered as one of a) no comorbid condition, b) a minor comorbid condition, or c) a major comorbid condition.

UM opportunity: This value is derived from a comparison of Diagnoses Related Groups (DRG) length of stay and clinical length of stay (LOS). This is useful because a DRG-LOS value greater than the clinical-LOS value defines an opportunity for a well-managed UM team to achieve early discharge without compromising patient safety.

ReAdmission Risk: This value calculates the percent risk of the case becoming a UM outlier or being readmitted within about 1 month of discharge. It, for example, can be derived from comparing the medical and social barrier data of the case with a defined matrix in the hospital and medical group datasets 110.

Inpatient Insurance Criteria Compliance: The clinical profile of a private insurance patient is compared to similar profiles of patients in the dataset 110 that had insurance denials. It can offer an admitting user with a Yes/No opinion as to whether the patient meets insurance criteria for hospitalization.

Ontrak measure: This measures changing parameters of medical and social barriers in the follow-up encounters with a patient. The acuity index and days from admission are divided. This modified score is then compared to a sub-cohort in the database that were selected for being ontrack for discharge (that is, these cases were discharged by the allocated time). A similar calculation is performed on these cases. Deviation from the ontrack cases in the database produces the score. Therefore if the deviation is slight (i.e., 1-4) the case is ontrack while if the deviation is great, the case is offtrack.

Financial performance: This measure ascribes a bed cost/day to each day that a patient stays in the hospital. If the length of stay exceeds the time allowed by Medicare or insurance, the cost of that day is debited in an optionally generated report. This report can be performed in real-time by financial personnel of the hospital.

Thus, the dataset 110 can be viewed as a consolidation of the underlying data of all the thousands of patient histories along with historical information about their clinical stay and insurance outcomes. Within a particular admitting diagnosis, the patient histories are organized according to a plurality of different factors (for example, 8 datapoints described above) into a plurality of identifiable data patterns. Correlated with each such pattern is information helpful for predicting UM information for a new patient that closely matches a particular pattern.

Once the UM information is generated it can be used in the Inpatient Management System and Database in a variety of different ways. In particular, a system that facilitates the inpatient workflow can then be utilized that includes intuitive user interfaces, communications tools, analytical tools, and other tools accessible by the entire inpatient team. Such a system enables a team of physicians, reviewers, ancillary services, and administration to have a streamlined coordinated workup beneficial for timely, high-quality care.

As described earlier with respect to FIG. 1, the Inpatient Management System and Database 118 can operate as a web service application that allows communication between the healthcare team and the system, generate reports related to the patients' clinical stay, and generate reports related to UM related data. The system 118 can also continue to learn from patients' clinical stays to update and maintain the relevancy and accuracy of the dataset 110. Furthermore, information from other Inpatient Management Systems and other datasets can also be utilized to update the information provide by the analysis engine 116.

With the data that is available and that can be calculated from the inpatient management system and database 118, a number of different reports can be generated and presented to various team members. For example, the hospital administrator, the attending physician, the ancillary service provider, the floor nurse, the case manager, and the medical reviewer can all be provided with reports that are tailored to assist them in performing their respective functions in the inpatient workflow. Thus, the system 118 includes communications modules, report generating modules, user input modules, database tables, and application logic tying all those other aspects together into a service application usable by any member of the healthcare team from local or remote devices (e.g., smartphones, computers, PDAs, etc.).

Example screenshots are provided herein that illustrate a number of user interface design features useful for entering data within the Inpatient Management System and Database 118. Also, a number of example report formats are provided as well. These examples are not intended to be exhaustive of the types of data that can be entered into, or reported from, the present system 118. Thus, these examples are not intended to limit the scope of the present invention to only the information illustrated within the accompanying figures. One feature that is illustrated in a number of screens to some degree is the ability to drill down into the data. One of ordinary skill will recognize that a high level report such as a calendar can have a day that can be drilled-down to see patient names which in-turn can be drilled-down to reveal general patient information, which in turn can be drilled-down to reveal detail treatment information and results, which in turn could theoretically be drilled-down another layer. Embodiments of the present invention contemplate linking the information within the inpatient management system and database in such a way that a report generator can produce a report with drill-down links to all aspects of the underlying data that is useful for a particular report.

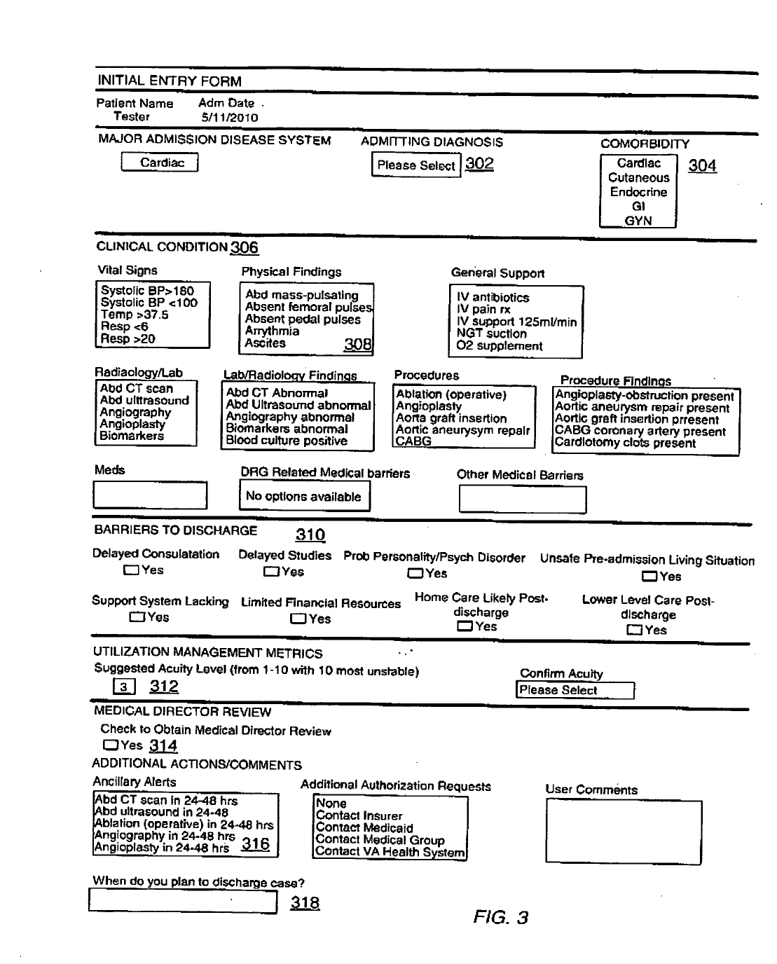

FIG. 3 illustrates an example initial inpatient entry form with which a case manager or other admitting personnel can begin the management of this patient within the inpatient management database and system 118 of FIG. 1. In this screen, the case manager can designate the admitting diagnosis 302, any comorbidity 304 and other information 306 useful for tracking the patient's clinical stay, workup and utilization management information. The selection submenus (an example is submenu 308) reflects choices relevant to the admitting diagnosis. Thus, when a user selects different options for the admitting diagnosis box, the choices presented in the other selection boxes change as well to be pertinent to that admitting diagnosis. Other information that can be entered and is helpful includes barriers to discharge 310 and ancillary alerts 316. As described above, one calculated value based on the menu selections is the suggested acuity level which reflects both the severity of the patient's condition and the level of care that is anticipated for that patient. This calculated acuity level value, or acuity index, can also rely partly on the information from the historical dataset and also be adjusted by the user if desired. Utilizing the interface screen of FIG. 3, the user can provide the information that is useful by the analysis engine 116 to generate the above-mentioned UM information.

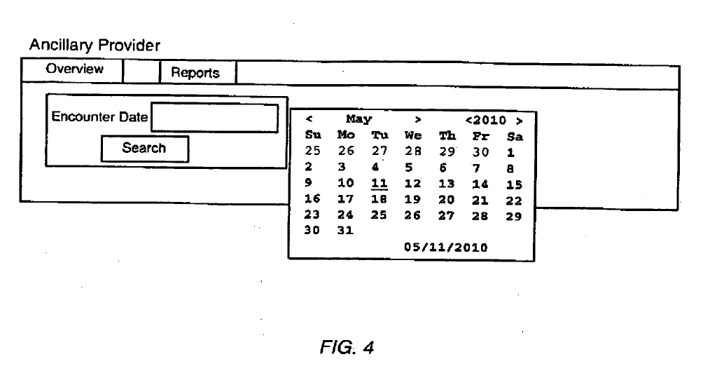

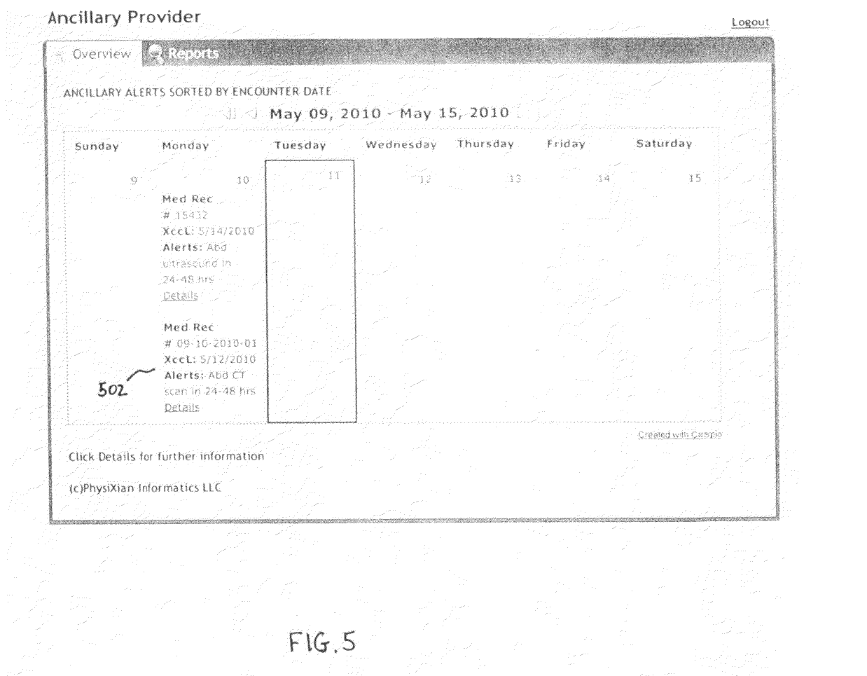

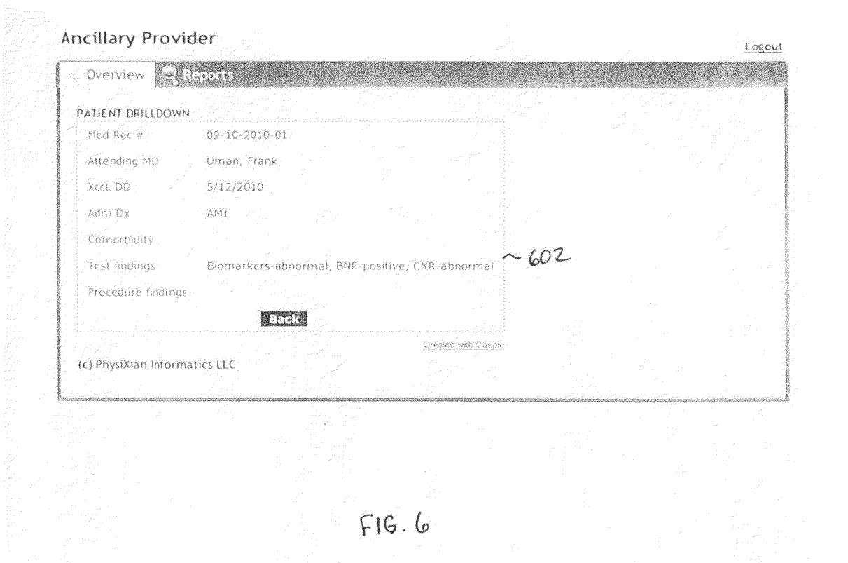

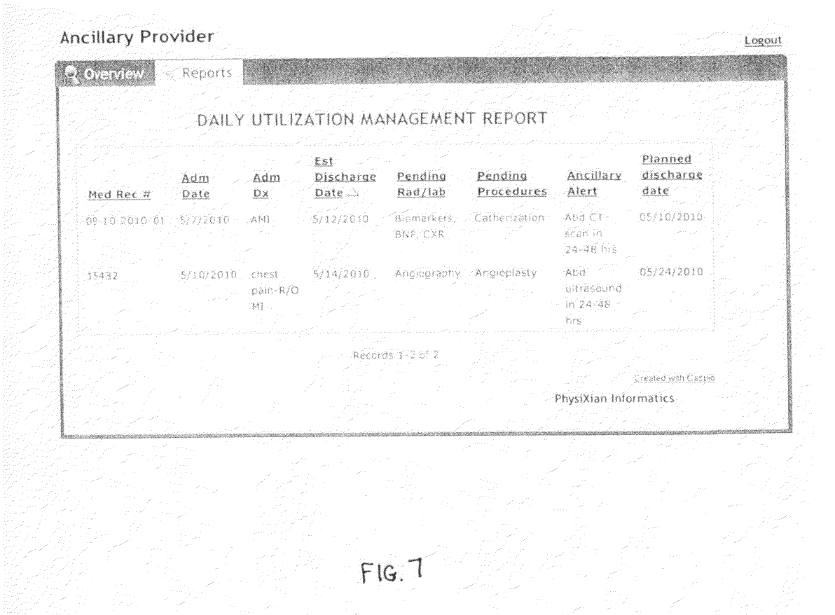

FIG. 4 is an example of an initial screen that might be provided to an ancillary service provider that allows them to use a calendar or other search function to select a range of dates to investigate further. From this initial screen of FIG. 4, a particular date range can be selected and displayed as shown in FIG. 5 that shows on a daily basis what resources are anticipated for that ancillary service provider. Using this information the ancillary service provider can plan staff and resources to ensure that they do not delay the patient's clinical stay. FIG. 6 is an example of how a user can drill down into the data to see more information 602 about a patient or other data object.

FIG. 7 shows another type of report that assists a health care team member. The report of FIG. 7 is an example of a daily report indicating information scheduled to occur for today's date. Although specifically shown for the ancillary service provider, a similar daily report can be generated for an attending physician, a hospital administrator, etc. However, in their daily reports the information included would be those pieces of data helpful to them in performing their particular function within the health care team.

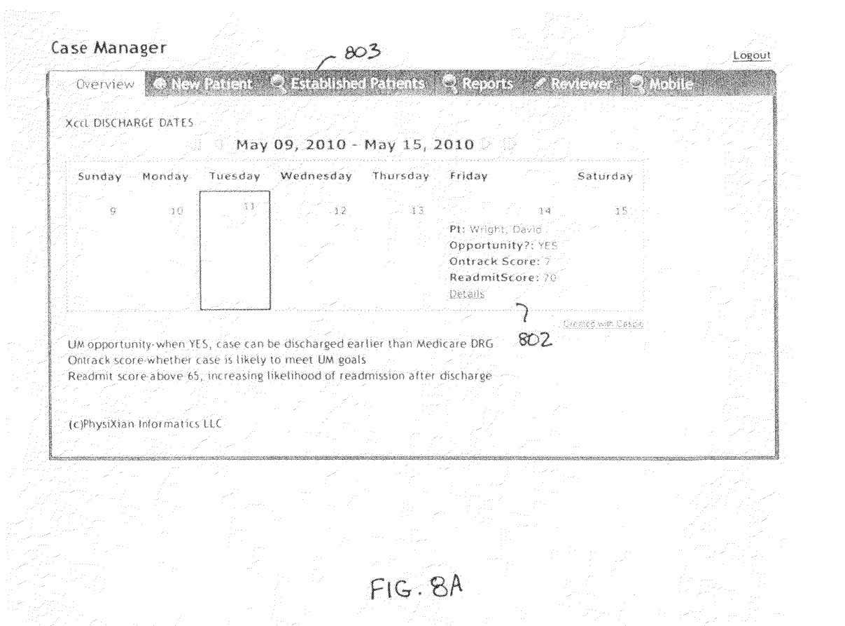

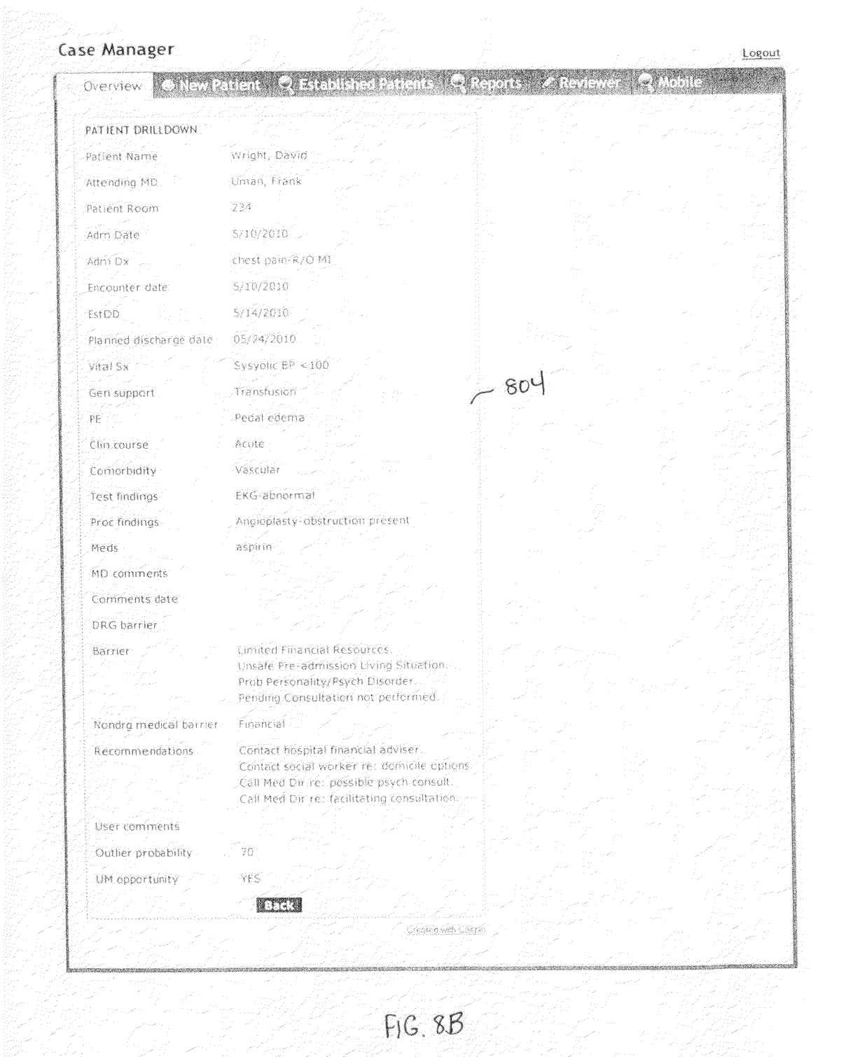

A Case Manager is also another health care team member that can receive tremendous benefits from an Inpatient Management Database and System as described herein. FIG. 8 displays an example overview screen for a week that shows daily information 802 about patient status. The example screen of FIG. 8A shows only a single patient for Friday May 14, 2010 but in an actual setting, these days would be full of different patients and the case manager would be able to zoom in to see information as needed. As an example, the present system provides three pieces of information that is particularly helpful to a Case Manager as discussed above: UM Opportunity, OnTrack Score, and ReAdmit Score.

The tabs 803 near the top of the interface screen show example areas that may be of interest to a Case Manager; however, other tabs could be included as well without departing from the scope of the present invention. For example, there is a tab for entering a new patient's information, a tab to explore information about existing patients, a tab that allows a Case Manager to select from a variety of reports, a tab to see what activity or information a Medical Reviewer might have performed or provided, and a tab to send information to a mobile device.

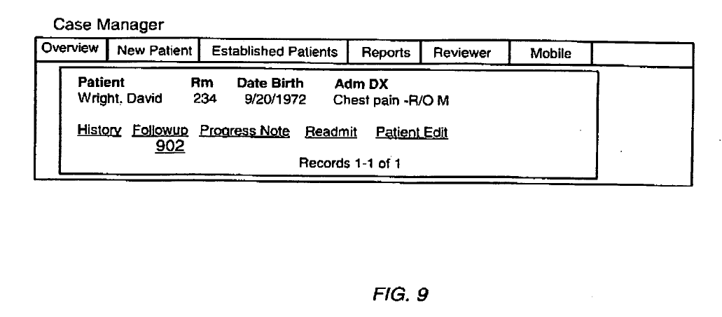

FIG. 8B shows a detailed page 804 of information about the patient 802 of FIG. 8A. FIG. 9 illustrates a table that has rows corresponding to established patients within the system. Part of this table has links 902 to different reports, or screens of data, that may be helpful to a Case Manager. For example, a Case Manager may find it useful to be able to view the history of a patient, view details of a follow-up encounter with a patient, view a Progress Note about a patient, readmit a patient for a separate reason, and also edit patient demographic information.

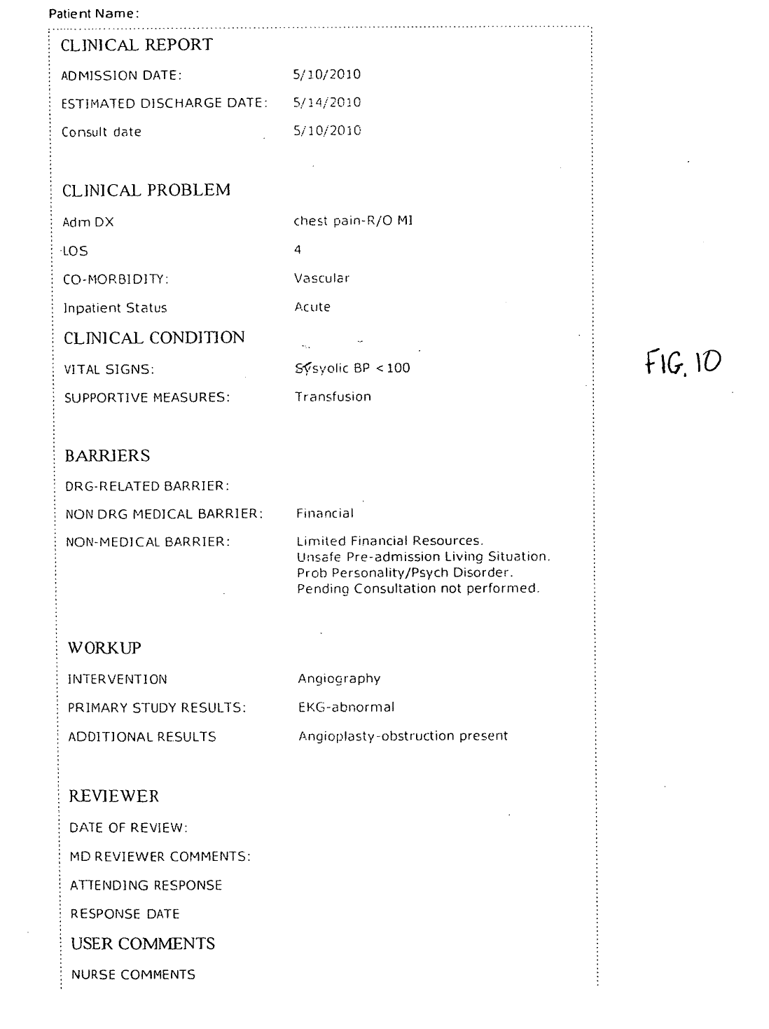

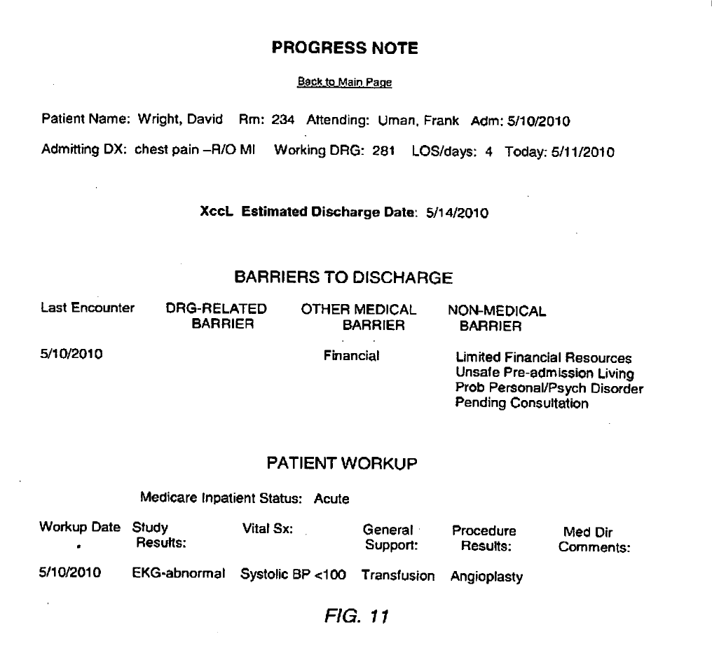

FIG. 10 illustrates the type of information that can be included in a follow-update and FIG. 11 illustrates examples of the types of information useful in a Progress Note. In particular, the Progress Note is a report that is useful for almost all healthcare team members as it provides a concise report with critical UM information such as any barriers to discharge, current workup results, and expected discharge date.

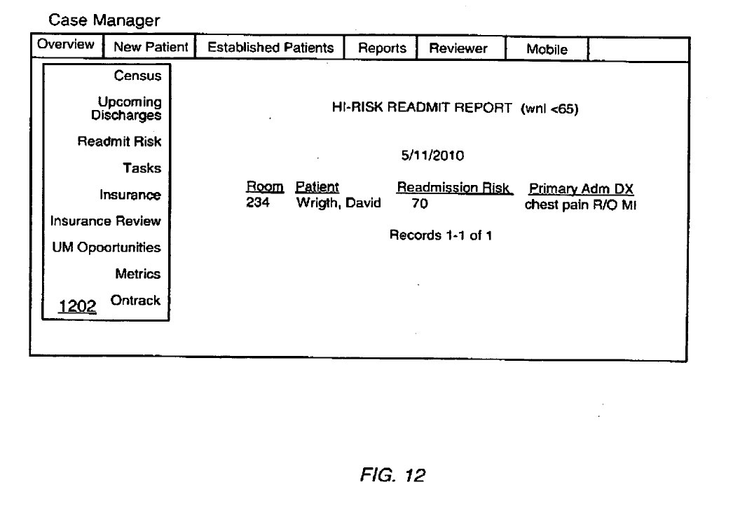

FIG. 12 is another example of one type of report that is beneficial to a Case Manager. In FIG. 12 a table is generated that displays the patients along with their readmission risk. As mentioned above, the dataset 110 includes information about patients that relate to their readmission status. Thus, using the current patient's multiple points of data (e.g., the 8 points mentioned previously), a scaled score (for example 0-100) can be assigned to indicate their readmission risk. This score changes and is updated as the patient progresses through their clinical stay. One example score would be simply a percentage, based on the historical dataset, of what patients having similar 8 data points were themselves readmitted within 1 month of discharge.

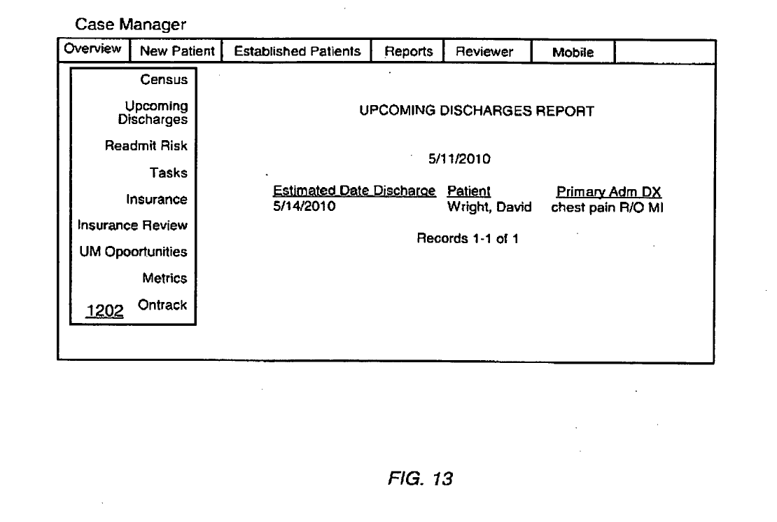

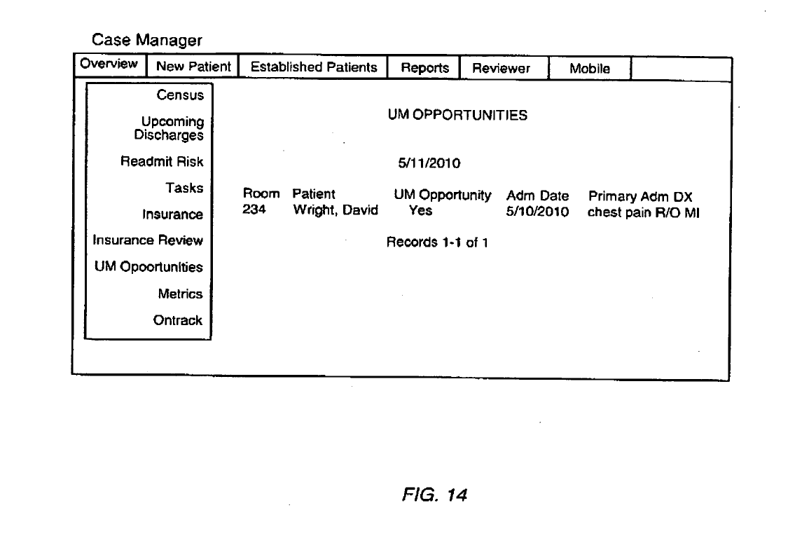

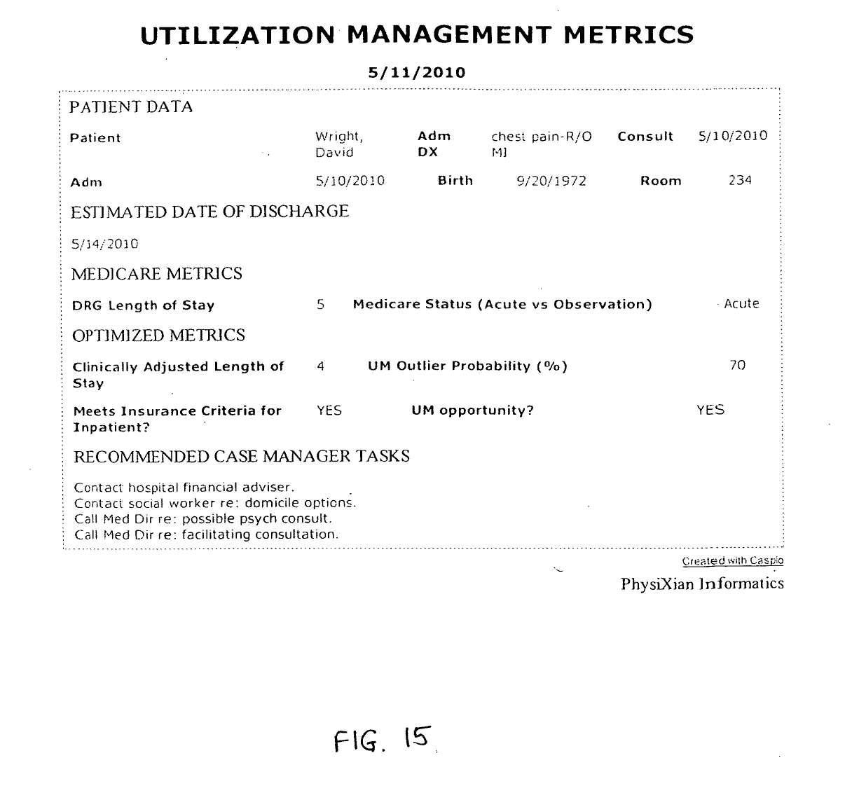

FIG. 12 also shows tabs 1202 along the left side that list example types of reports that a Case Manager may find helpful. FIG. 13 shows one of these helpful reports which includes a list of patients expected to be discharged within x days, where x can be a selectable number in order to limit the data to a size manageable and useful to the Case Manager. FIG. 14 particularly shows a list of patients in which a UM opportunity exists. These patients are ones where the actual LOS can be less than the DRG-LOS if managed properly. FIG. 15 details a report of UM metrics for a particular patient. For example, the report can show what the Medicare Status is, what the DRG-LOS is, what the clinical LOS is projected to be, whether this provides a UM opportunity, whether or not Insurance Criteria are met, and what the readmit risk is.

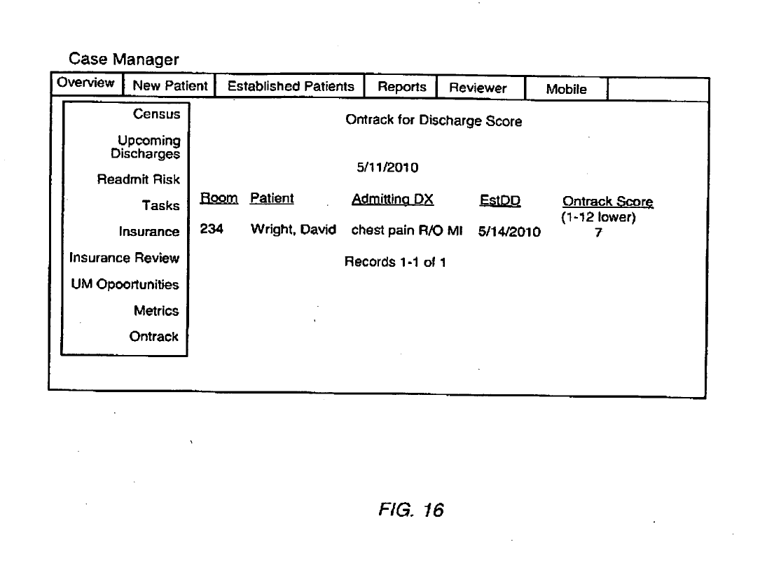

An OnTrack report, as shown in FIG. 16, provides a table which lists the patients along with their OnTrack score. The display can be sorted (either ascending or descending) by the OnTrack score which indicates whether or not the patient is progressing as intended towards the discharge date. The OnTrack score can also indicate that there is a problem. This indication would allow a Case Manager or other member to investigate what delay or barrier to discharge exists and take steps to remedy the issue.

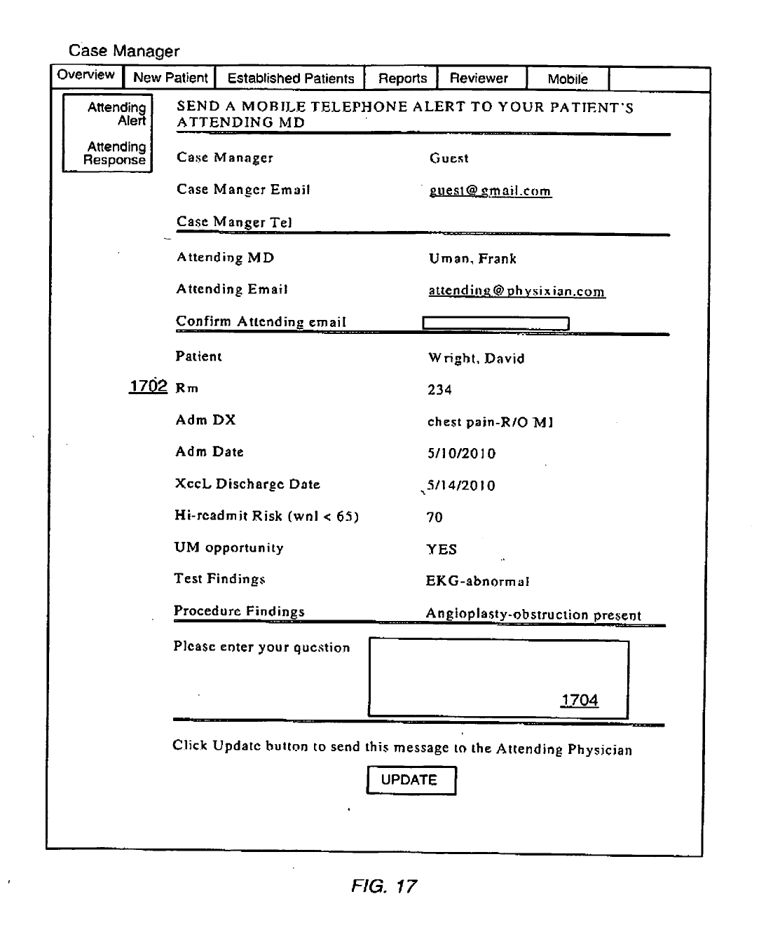

Communication among team members is an important component of the UM process and the envisioned system includes functionality as shown in FIG. 17 that allows a message to be sent to an email address or phone number to another healthcare team member such as the attending physician. The message can include clinical information 1702 along with a customizable text portion 1704. In this way the physician receives a message which typically includes enough background information to allow them to answer any inquiries within the message.

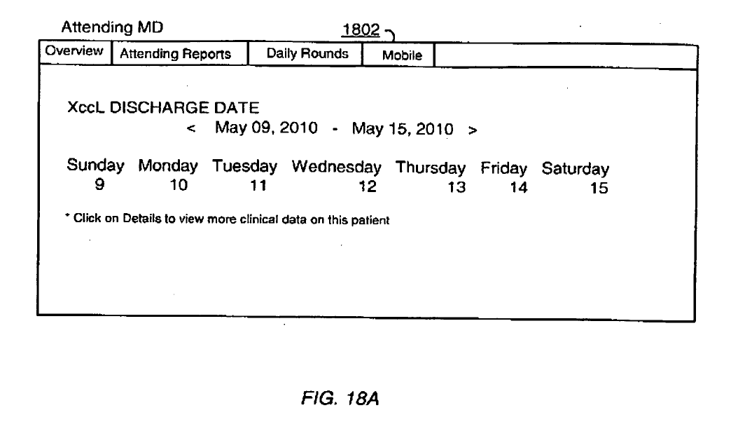

The Mending Physician also benefits from a number of reports and information screens available from the presently described system. As shown in FIG. 18A, a screen can be provided that has helpful tabs 1802 to allow the Physician to select different reports or information. For example, the Physician can see an overview of their week (shown in FIG. 18A) they can see a report for a particular patient (as shown in FIG. 18B), they can see a table of their daily rounds for a particular day (along with drill-down capability), and they can access a screen to allow themselves to send a message to another email address. Additionally, specific client applications (e.g., an iPhone App) can be developed to allow the Physician to access the Inpatient Management System and Database 118 in order to interface with the functionality described above.

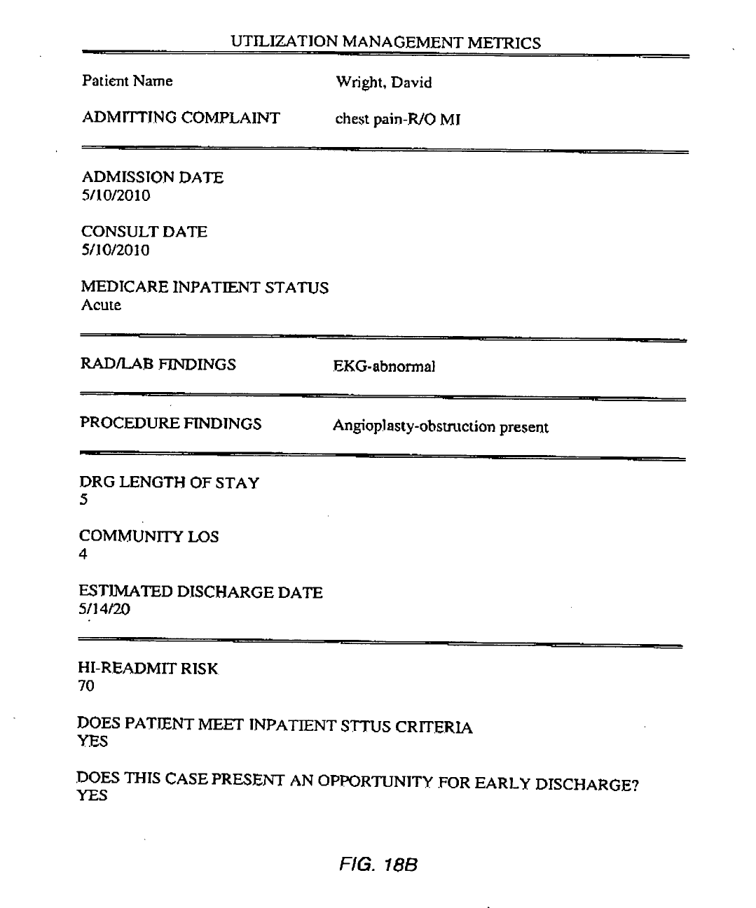

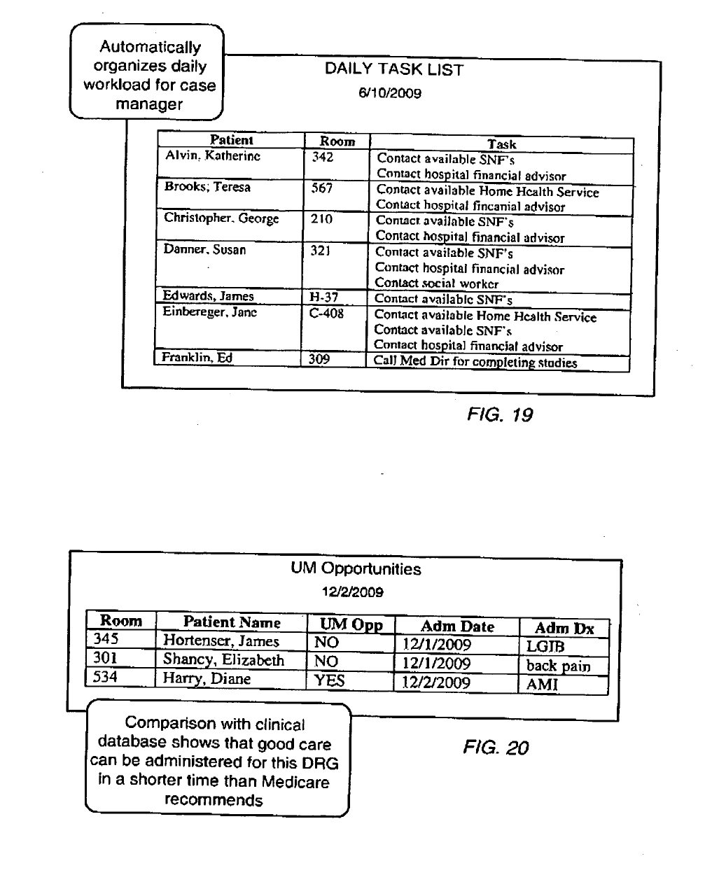

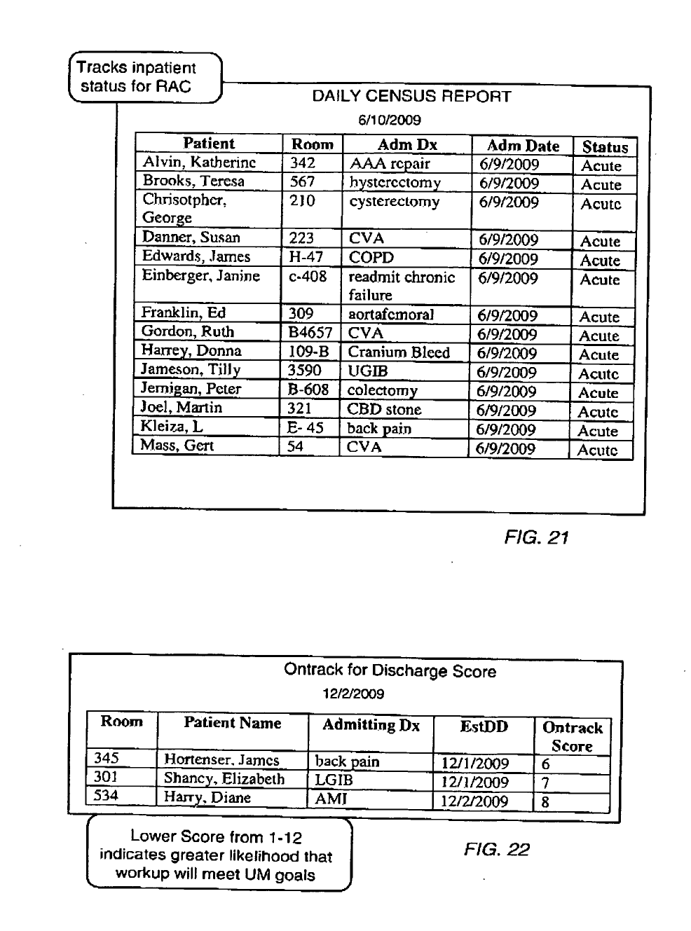

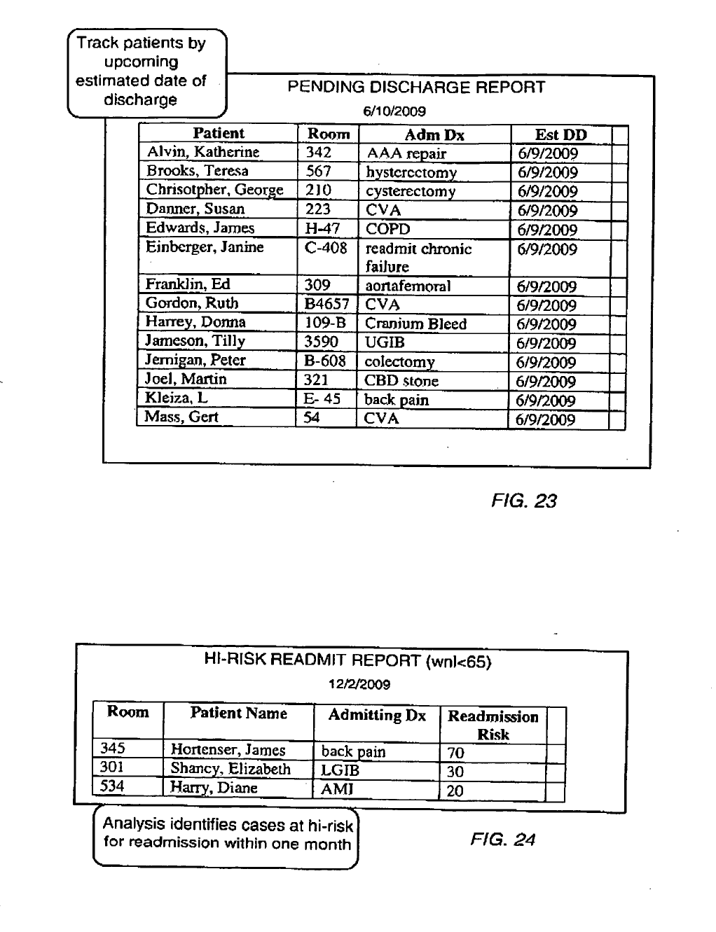

FIGS. 19-24 show other example reports and the types of information that can be generated and provided by the presently contemplated system. As described herein, an Inpatient Management System and Database is contemplated that coordinates data between the inpatient healthcare team, provides UM metric data for real-time decision making, provides clinical record access to attending staff 24 hours a day, seven days a week, provides financial interpretation for Hospital Administrators, and assists Ancillary Service Providers in scheduling and resource management. Furthermore, the entering of inpatient data will automatically generate three other pieces of information: 1) an estimated discharge date, 2) an insurance outlier report (e.g., historically the length of stay at which point those patients did not get full reimbursement for a stay that is longer than the length of the current patient's present stay), and 3) a Progress Note which is the primary communication vehicle for UM goals to the inpatient team. A financial Report can also be provided that calculates based on the actual LOS the unreimbursed costs that the Hospital is incurring each day or other specified time period.

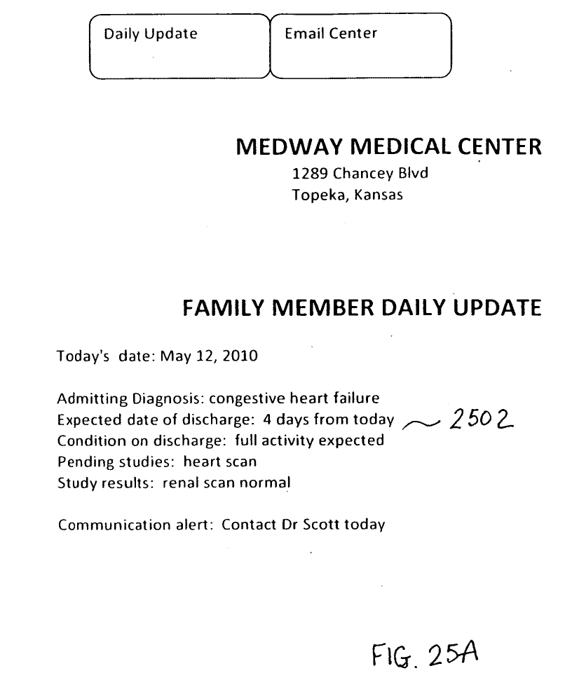

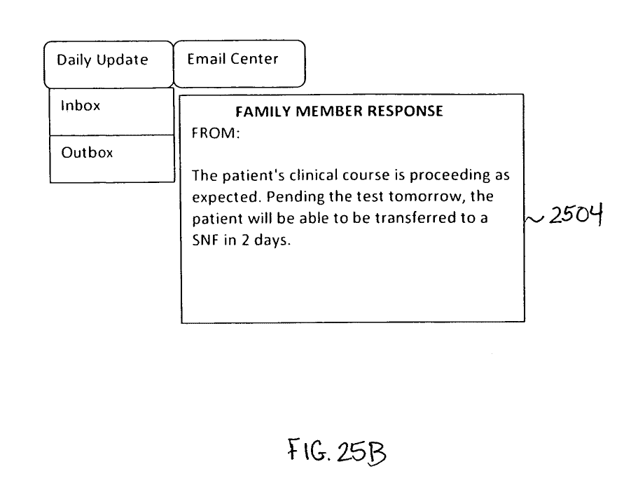

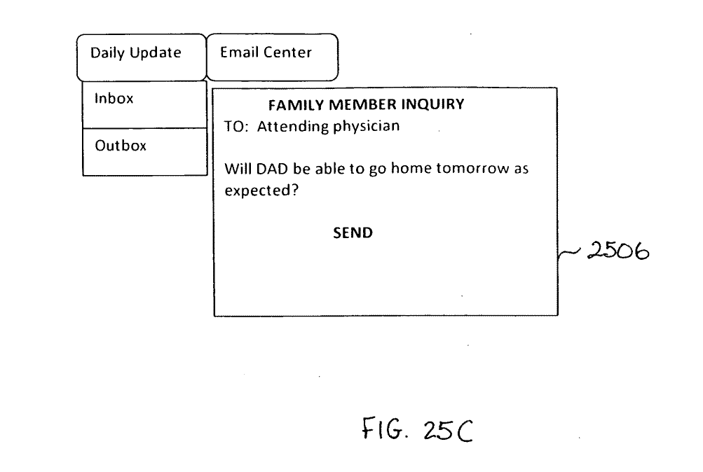

FIGS. 25A-25C relate to an aspect of the presently described system in which family members are included in the health care team. A portal can be provided for them similar to those discussed earlier with respect to the physicians, case managers, etc. In FIG. 25A, an initial page for a patient can include an status message 2502 that quickly informs family members of the progress and status of the patient. FIG. 25B illustrates a screen that allows the family members to view a more directed message 2504 that may have been generated in response to an inquiry. Either the case manager or the Physician (or any other healthcare team member) can generate such messages. FIG. 25 C, for example, shows such an interface screen that provides a window 2506 in which a family member can enter an inquiry directed to another member of the healthcare team.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for admitting a patient, comprising:
creating an inpatient value set by collecting a respective value for each of a plurality of datapoints about the patient;
comparing the inpatient value set with an historical dataset, the dataset representing a plurality of other patients each having a respective corresponding value set for the plurality of datapoints associated with a respective set of utilization management information;
based on the comparison, identifying within the historical dataset a particular set of utilization management information that is associated with a particular corresponding value set which is substantially the same as the inpatient value set; and
based on the particular set of utilization management information, calculating a predicted length of stay for the patient.

2. The method of claim 1, further comprising:
identifying a first admission diagnosis for the patient; and
wherein the particular corresponding value set includes an associated second admission diagnosis and the first and second admission diagnoses are the same.

3. The method of claim 1, wherein the plurality of datapoints include any comorbidity factors.

4. The method of claim 3, wherein the plurality of datapoints include vital signs of the patient.

5. The method of claim 4, wherein the plurality of datapoints include an identification of one or more general supportive measures for the patient.

6. The method of claim 5, wherein the plurality of datapoints include an identification of physical findings, study findings, and procedure findings.

7. The method of claim 6, wherein the plurality of datapoints include an identification of any pending studies and any pending procedures.

8. The method of claim 1, further comprising:
determining a first length of stay corresponding to a time period for which an insurance entity will provide payment for the patient; and
comparing the predicted length of stay and the first length of stay to determine whether the first length of stay is less than, equal to, or greater than the predicted length of stay.

9. The method of claim 1, wherein the plurality of datapoints include an identification of whether a respective patient was readmitted within about one month of discharge.

10. The method of claim 9, further comprising:
determining a risk of readmission value for the patient based on how similar the inpatient data set and the particular corresponding value set are.

11. The method of claim 1, further comprising:
updating the inpatient value set based on follow-up encounters with the patient; and
updating the predicted length of stay based on the updated inpatient value set.

12. An inpatient management system comprising:
a data entry interface configured to create an inpatient value set by collecting a respective value for each of a plurality of datapoints about a patient;
a communication channel with an analysis engine for an historical dataset, the historical dataset representing a plurality of other patients each having a respective corresponding value set for the plurality of datapoints associated with a respective set of utilization management information;
wherein the inpatient management system is configured to transmit the inpatient value set to the analysis engine and, in response, to receive from the analysis engine a particular set of utilization management information that is associated with a particular corresponding value set within the historical dataset which is substantially the same as the inpatient value set; and
a calculator configured to calculate a length of stay for the patient based on the particular set of utilization management information.

13. The inpatient management system of claim 12, further comprising:
an electronic record maintained by the inpatient management system for the patient that includes a predicted discharge date based on the calculated length of stay.

14. The system of claim 13, wherein the electronic record includes an indicator of whether the predicted length of stay is less than, equal to, or greater than a length of stay corresponding to a time period for which an insurance entity will provide payment for the patient.

15. A method for calculating a predicted length of stay for a patient comprising:
receiving, from a requestor, an inpatient value set that includes a respective value for each of a plurality of datapoints about the patient;
comparing the inpatient value set with an historical dataset, the dataset representing a plurality of other patients each having a respective corresponding value set for the plurality of datapoints associated with a respective set of utilization management information;
based on the comparison, identifying within the historical dataset a particular set of utilization management information that is associated with a particular corresponding value set which is substantially the same as the inpatient value set;
based on the particular set of utilization management information, calculating a predicted length of stay for the patient; and
transmitting the predicted length of stay to the requestor.

16. The method of claim 15, further comprising:
receiving, from the requestor, a first admission diagnosis for the patient; and
ensuring the particular corresponding value set includes an associated second admission diagnosis that is the same as the first admission diagnosis.

17. The method of claim 16, wherein the plurality of datapoints include any comorbidity factors

18. The method of claim 17, wherein the plurality of datapoints include vital signs of the patient.

19. The method of claim 18, wherein the plurality of datapoints include identification of one or more general supportive measures for the patient.

20. The method of claim 19, wherein the plurality of datapoints include an identification of physical findings, study findings, procedure findings, any pending studies and any pending procedures.
